(19) United States
(12) Patent Application Publication
(10) Pub. No.: US 2018/0366281 A1
(43) Pub. Date: Dec. 20, 2018

(54) METHODS AND SYSTEMS OF SWITCHING DEVICES HAVING PROGRAMMABLE FUNCTIONALITY MARKINGS

(71) Applicant: HAO MIN, NANJING (CN)

(72) Inventor: HAO MIN, NANJING (CN)

(21) Appl. No.: 15/022,204

(22) PCT Filed: Mar. 7, 2016
(86) PCT No.: PCT/CN2016/075762

§ 371 Date: Mar. 15, 2016

(51) Int. Cl. H01H 9/18; H01H 3/20; G06F 3/041; G09G 3/32; G09G 3/36; G09G 3/20

(52) U.S. Cl. CPC H01H 9/181; H01H 3/20; G06F 3/041; H01H 2003/0293; G09G 3/36; G09G 3/2003; G09G 3/32

(57) ABSTRACT

The present invention relates to a switching device having programmable functionality markings. The switching device has: a switch, a functionality marking programmer, a functionality marking display, and a control module. The switch is used to control power supply to an electrical appliance. The functionality marking programmer allows a user to designate the switch to a specific functionality with a corresponding functionality marking. The functionality marking display displays the functionality marking programmed by the functionality marking programmer. The control module includes a processor and a memory. The memory stores computer executable instructions. When executed at the processor, the computer executable instructions is configured to: receive functionality marking programming instructions from the user via the functionality marking programmer, designate the functionality of at least one switch with a functionality marking according to the functionality marking programming instructions received, and display the programmed functionality marking of the switch via the functionality marking display.

### FIELD

The present invention generally relates to electrical switching system, and more particularly to a method and an apparatus for programming and using switching devices having programmable functionality markings.

### BACKGROUND

Switch plate is widely used on a switch to cover the switch itself and the switch is used to control various electrical appliances or lightings. As new electrical appliances and lightings become more and more popular, the walls of household or offices become more and more crowded with difference types of switches. For example, in a bathroom, there are roof lights, vanity lights, ceiling fans, ventilation fans, spotlights, spa or whirlpool and more, and each of these electrical appliances and lightings requires at least one switch. The switches for these electrical appliances and lightings are usually installed near the door or the entrance, so there may be several switches installed in one place. Without proper identifications, it is difficult to distinguish one switch from another. The lack of functionality markings causes confusions. Unless a user can memorize the location of each switch, more often than not, he/she has to turn each and every one of several switches to achieving his/her goal of turning on or off one of the lights or electrical appliances. Therefore, it is desirable to identify the functionality of a switch with functionality markings.

Therefore, a heretofore unaddressed needs still exist in the art to address the aforementioned deficiencies and inadequacies.

### SUMMARY

In one aspect, the present invention relates to a switching device having programmable functionality markings. In certain embodiments, the switching device has: at least one switch, a functionality marking programmer, a functionality marking display, and a control module. The switch is used to control power supply to an electrical appliance. The functionality marking programmer allows a user to designate the switch to a specific functionality with a corresponding functionality marking. The functionality marking display displays the functionality marking of the switch programmed by the functionality marking programmer. The control module includes a processor and a memory. The memory stores computer executable instructions and various functionality markings of the switch. When executed at the processor, the computer executable instructions is configured to: receive functionality marking programming instructions from the user via the functionality marking programmer, designate the functionality of at least one switch with a functionality marking according to the functionality marking programming instructions received, and display the programmed functionality marking of the switch via the functionality marking display.

In certain embodiments, the switching device includes a face plate. The face plate has an outside surface, and an inside surface. A circuit board is installed on the inside surface of the face plate, and the functionality marking display is installed on the outside surface of the face plate. The circuit board includes the control module, and the control module has the processor, and the memory. The control module is electrically coupled to the functionality marking programmer for receiving the functionality marking programming instructions, and the functionality marking display for displaying the programmed functionality marking.

In certain embodiments, the functionality marking display includes: a light emitting diode (LED) array having a multiple LEDs each having different color, a multi-color LED, a functionality marking display window on the face plate showing functionality markings on a dial, an LED screen, a liquid crystal display (LCD) screen, and a touchscreen having functionality marking programmer and functionality marking display.

In certain embodiments, the functionality marking includes: a selection of various functionality markings displayed on a display screen, a selection of various functionality markings displayed on the dial, a selection of color displays of the LED array color-coded for the functionalities, and a selection of color displays of the multiple-color LED color-coded for the functionalities. The various functionality markings include: different phrases describing the predetermined functionalities, different icons showing the predetermined functionalities, and different functionality marking signs on the dial showing the predetermined functionalities. The display screen includes: the LED screen, the LCD screen, and the touchscreen.

In certain embodiments, the functionality marking programmer includes: a functionality marking selection push button, a functionality marking selection icon on the touchscreen, the dial, and a functionality marking input interface. The switch includes: a toggle switch, a rotary switch, a push button switch, a touch switch, a push switch, a pull switch, a rocker switch, a slide switch, a light sensing switch, a motion sensing switch, and an LCD touchscreen switch.

In another aspect, the present invention relates to a method of using a switching device having programmable functionality markings. In certain embodiments, the method includes: receiving functionality marking programming instructions from a user via a functionality marking programmer of the switching device, designating the functionality of at least one switch with a functionality marking according to the functionality marking programming instructions received, and displaying the programmed functionality marking of the switch via a functionality marking display.

In certain embodiments, the switching device includes: the at least one switch, the functionality marking programmer, the functionality marking display, and a face plate. The switch is used to control power supply to an electrical appliance. The functionality marking programmer allows a user to designate the switch to a specific functionality with a corresponding functionality marking. The functionality marking display displays the functionality marking of the switch programmed by the functionality marking programmer. The face plate has an outside surface, and an inside surface. A circuit board is installed on the inside surface of the face plate. The functionality marking display is installed on the outside surface of the face plate. The circuit board includes a control module. The control module includes a processor, and a memory. The control module is electrically coupled to the functionality marking programmer and the functionality marking display.

In certain embodiments, the operation of receiving functionality marking programming instructions includes: pressing a functionality marking selection push button by the user to select one of the functionality markings, pressing a functionality marking selection icon on the touchscreen by the user to select one of the functionality markings, turning a dial by the user to select one of the functionality marking signs, and receiving the functionality marking programming instructions from a functionality marking programming device via a functionality marking input interface.

In certain embodiments, the operation of designating the functionality includes: pressing the functionality marking selection push button by the user to select one of the functionality markings repeatedly until the desired functionality marking is displayed on the functionality marking display, pressing the functionality marking selection icon on the touchscreen by the user to select one of the functionality markings repeatedly until the desired functionality is displayed on the touchscreen, turning the dial by the user to select one of the functionality markings repeatedly until the desired functionality marking sign is displayed in a functionality marking display window of the face plate, and using the functionality marking programming device by the user to program the functionality marking via the functionality marking input interface.

In certain embodiments, the operation of displaying the programmed functionality marking includes one or more of the following: displaying a predetermined color through an LED array, displaying a predetermined color through a multi-color LED, displaying a predetermined functionality marking sign on the dial, displaying a predetermined phrase on a display screen, and displaying a predetermined icon on the display screen. The predetermined color used for the LED array and the multi-color LED represents the designated functionality of the switch. The predetermined functionality marking sign is displayed on the dial through the functionality marking display window on the face plate. The predetermined functionality marking sign represents the designated functionality of the switch. Each of the predetermined phrase and the predetermined icon shown on the display screen represents the designated functionality of the switch. The display screen includes: an LED screen, an LCD screen, and a touchscreen.

In certain embodiments, the functionality marking includes: a selection of various functionality markings displayed on the display screen, a selection of various functionality markings displayed on the dial, a selection of color displays of the LED array color-coded for the functionalities, and a selection of color displays of the multiple-color LED color-coded for the functionalities. The various functionality markings include: different phrases describing the predetermined functionalities, different icons showing the predetermined functionalities, and different functionality marking signs on the dial showing the predetermined functionalities.

These and other aspects of the present invention will become apparent from the following description of the preferred embodiment taken in conjunction with the following drawings and their captions, although variations and modification therein may be affected without departing from the spirit and scope of the novel concepts of the disclosure.

### BRIEF DESCRIPTION OF THE DRAWINGS

The accompanying drawings illustrate one or more embodiments of the present invention, and features and benefits thereof, and together with the written description, serve to explain the principles of the present invention. Wherever possible, the same reference numbers are used throughout the drawings to refer to the same or like elements of an embodiment, and wherein:

FIG. 1 shows a perspective view of a switching device having functionality marking according to certain embodiments of the present invention;

FIG. 2 shows a block diagram of the switching device having functionality marking according to certain embodiments of the present invention;

FIG. 3 shows a front view of an exemplary switching device having an LED array showing functionality marking of the switching device according to one embodiment of the present invention;

FIG. 4 shows a front view of an exemplary switching device having a multi-colored LED showing functionality marking of the switching device according to one embodiment of the present invention;

FIG. 5 shows a front view of an exemplary switching device having an LED screen showing functionality markings according to one embodiment of the present invention;

FIG. 6 shows a front view of an exemplary switching device having an LCD screen showing functionality markings and a functionality marking input interface according to one embodiment of the present invention;

FIG. 7 shows a front view of an exemplary switching device having a touchscreen showing functionality marking according to one embodiment of the present invention; and

FIG. 8 shows a front view of an exemplary switching device having a dial showing functionality marking according to one embodiment of the present invention.

### DETAILED DESCRIPTION

The present invention is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present invention.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present invention will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

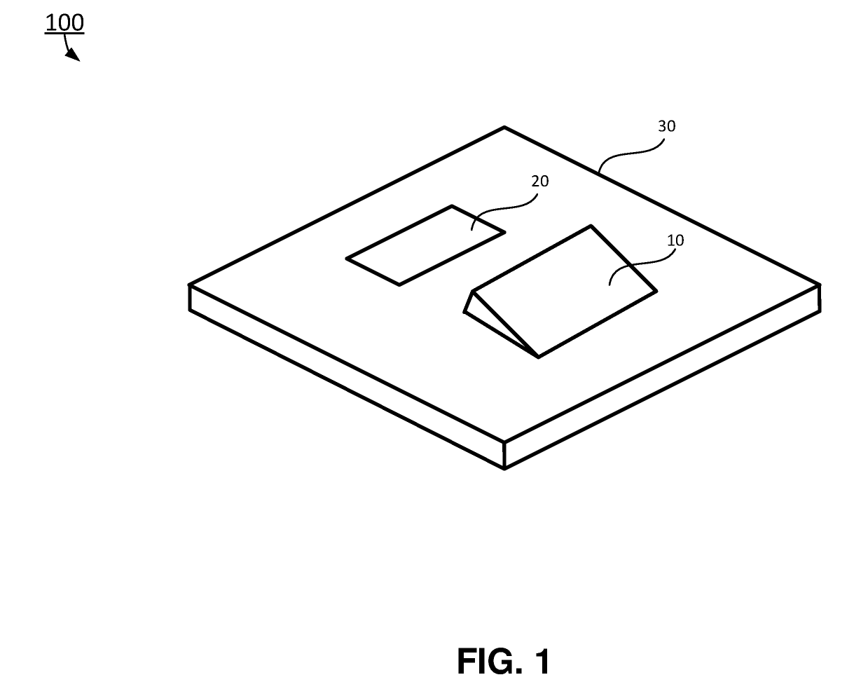

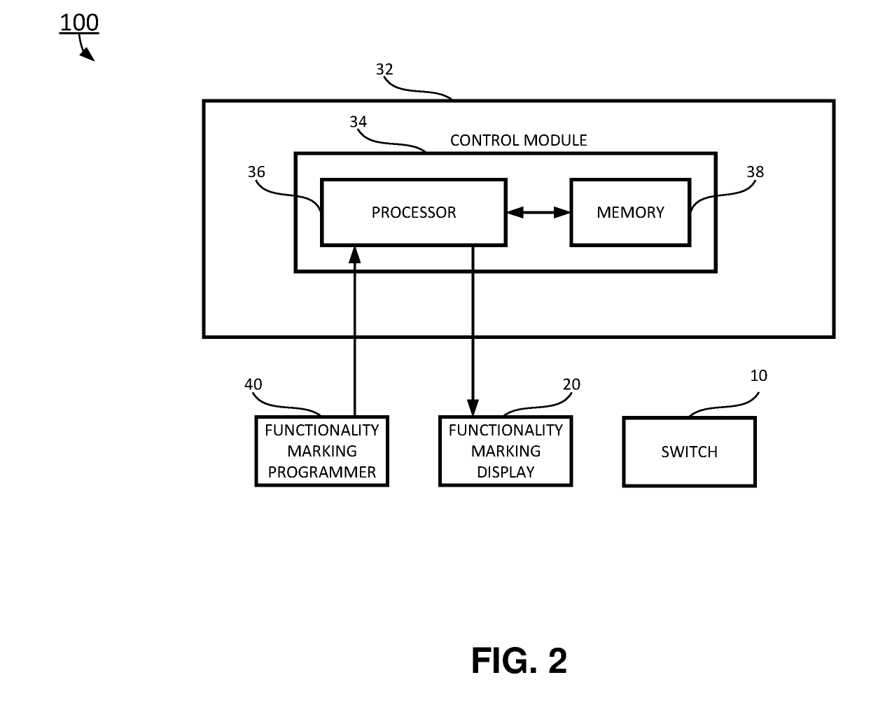

In one aspect, the present invention relates to a switching device 100 having programmable functionality markings. A perspective view of the switching device 100 is shown in FIG. 1, and a block diagram of the switching device 100 is shown on FIG. 2 according to certain embodiments of the present invention. The switching device 100 has: at least one switch 10, a functionality marking programmer 40, a functionality marking display 20, and a control module 34. The switch 10 is used to control power supply to an electrical appliance. The switch 10 can be one of: a toggle switch, a rotary switch, a push button switch, a touch switch, a push switch, a pull switch, a rocker switch, a slide switch, a light sensing switch, a motion sensing switch, and an LCD touchscreen switch.

In certain embodiments, the functionality marking programmer 40 allows a user to designate the switch 10 to a specific functionality with a corresponding functionality marking 27 (not shown in FIGS. 1 and 2). The functionality marking display 20 displays the corresponding functionality marking 27 of the switch 10 programmed by the functionality marking programmer 40. The control module 34 includes a processor 36 and a memory 38. The memory 38 stores computer executable instructions and various functionality markings of the switch 10. When executed at the processor 36, the computer executable instructions are configured to: receive functionality marking programming instructions from the user via the functionality marking programmer 40, designate the functionality of at least one switch 10 with a functionality marking 27 according to the functionality marking programming instructions received, and display the programmed functionality marking 27 of the switch 10 via the functionality marking display 20.

In certain embodiments, the switching device 100 includes a face plate 30 as shown in FIG. 1. The face plate 30 has an outside surface, and an inside surface. A circuit board 32, as shown in FIG. 2, is installed on the inside surface of the face plate 30, and the functionality marking display 20 is installed on the outside surface of the face plate 30 as shown in FIG. 1. The circuit board 32 has the control module 34, and the control module 34 includes the processor 36, and the memory 38. The control module 34 is electrically coupled to the functionality marking programmer 40 for receiving the functionality marking programming instructions, and the functionality marking display 20 for displaying the programmed functionality marking 27.

In certain embodiments, the functionality marking display 20 includes: a light emitting diode (LED) array 22 having a multiple LEDs each having a different color, a multi-color LED 24, a functionality marking display window 31 on the face plate 30 showing functionality marking sign on a dial 29, an LED screen 25, a liquid crystal display (LCD) screen 26, and a touchscreen 28 having functionality marking programmer 40 and functionality marking display 20.

In certain embodiments, the functionality marking 27 includes: a selection of various functionality markings displayed on a display screen, a selection of various functionality markings displayed on the dial 29, a selection of color displays of the LED array 22 color-coded for the functionalities, and a selection of color displays of the multiple-color LED 24 color-coded for the functionalities. The various functionality markings include: different phrases describing the predetermined functionalities, different icons showing the predetermined functionalities, and different functionality marking signs on the dial 29 showing the predetermined functionalities. The display screen includes: the LED screen 25, the LCD screen 26, and the touchscreen 28.

In certain embodiments, the functionality marking programmer 40 includes: a functionality marking selection push button 42, a functionality marking selection icon 44 on the touchscreen 28, the dial 29, and a functionality marking input interface 46. The switch 10 includes: a toggle switch, a rotary switch, a push button switch, a touch switch, a push switch, a pull switch, a rocker switch, a slide switch, a light sensing switch, a motion sensing switch, and an LCD touchscreen switch.

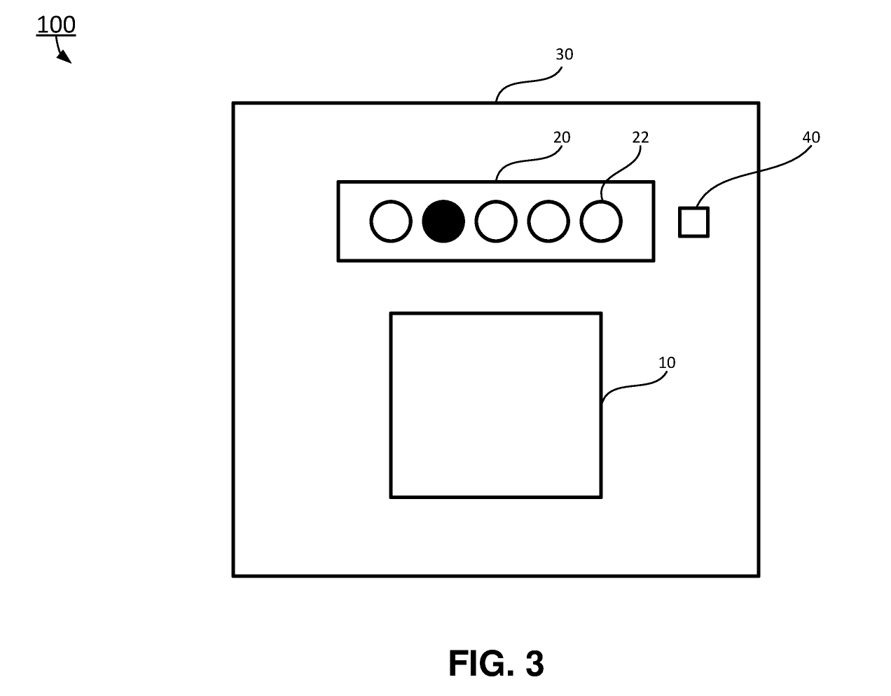

Referring now to FIG. 3, a front view of an exemplary switching device 100 having an LED array 22 showing functionality marking of the switching device 100 is shown according to one embodiment of the present invention. In this embodiment, the switching device 100 has the switch 10, the functionality marking display 20, the face plate 30, and the functionality marking programmer 40. The functionality marking display 20 has the LED array 22 that have multiple individual LEDs, each of the LEDs has a different color, and these different colors are used to represent the functionality of the switching device 100. For example, a green color LED represents a hallway light, a red color LED represents a light outside of the front door, and a white color LED represents a foyer light, etc. The functionality marking programmer 40 may be a push button. When the user presses the push button continuously for about three seconds, the switching device 100 enters into programming mode. The first LED will be lit indicating a first functionality. If the user decided that this color LED is not the color the user intended to use, the user can press the push button again to go to the next color LED. This process can be repeated until the color LED represents the color the user intended to use, then the user presses the push button continuously again for about three second to end the programming mode.

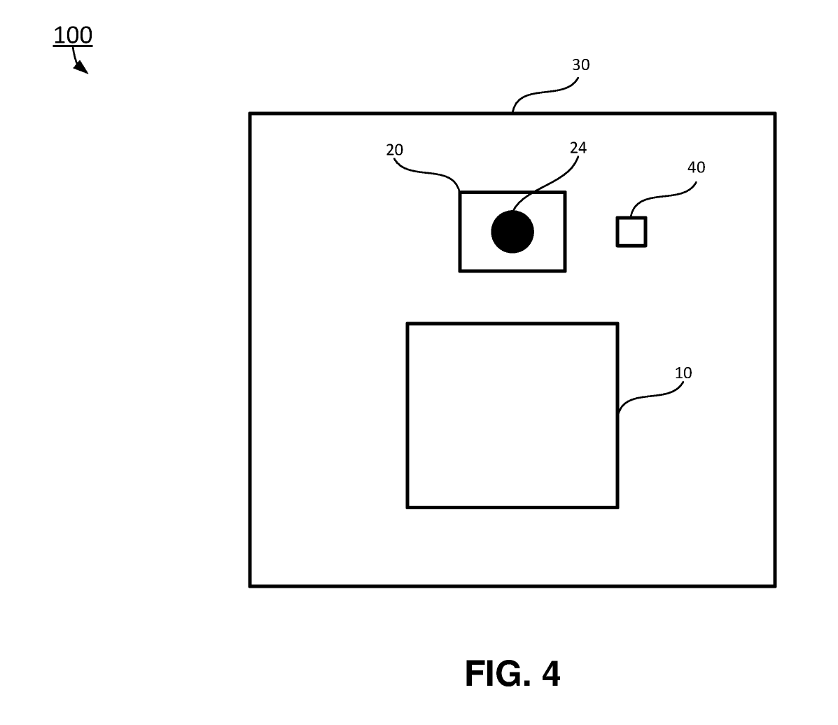

Referring now to FIG. 4, a front view of an exemplary switching device 100 having a multi-colored LED 24 showing functionality marking of the switching device 100 is shown according to one embodiment of the present invention. In this embodiment, the switching device 100 has the switch 10, the functionality marking display 20, the face plate 30, and the functionality marking programmer 40. The functionality marking display 20 has the multi-color LED that displays various different colors through the control module 34, each of the colors are used to represent the functionality of the switching device 100. The functionality marking programmer 40 is a push button. When the user presses the push button continuously for about three seconds, the switching device 100 enters into programming mode. The first color will be lit indicating a first functionality. If the user decided that this first color is not the color the user intended to use, the user can press the push button again to go to the next color. This process can be repeated until the multi-color LED 24 displays a color that represents the color the user intended to use, then the user presses the push button continuously again for about three second to end the programming mode.

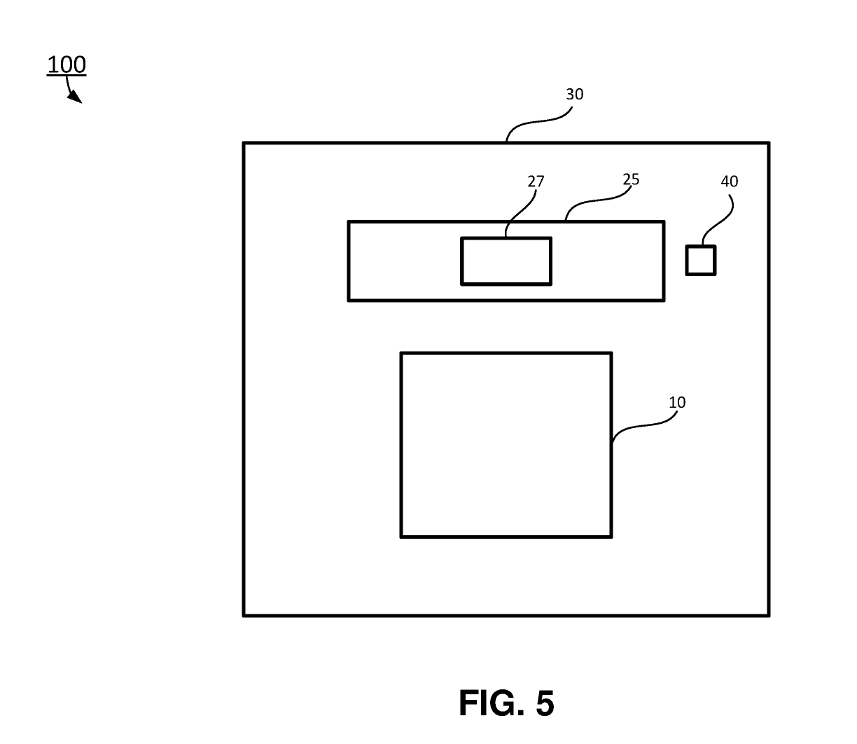

Referring now to FIG. 5, a front view of an exemplary switching device having an LED screen 25 showing functionality markings is shown according to one embodiment of the present invention. In this embodiment, the switching device 100 has the switch 10, the functionality marking display 20, the face plate 30, and the functionality marking programmer 40. The functionality marking display 20 is the LED screen 25 that displays various different phrases or icons 27 controlled by the control module 34, each of the various different phrases or icons 27 are used to represent various different functionalities of the switching device 100. The phrase such as ceiling fan, Hallway light, Spot Light etc. are used to describe the functionality of the switching device 100. Similarly various icons can be used to designate the functionalities of the switching device 100. These phrases or icons are predetermined, and stored in the memory 38. The functionality marking programmer 40 is a push button. When the user presses the push button continuously for about three seconds, the switching device 100 enters into programming mode. The first phrase or icon will be displayed indicating a first functionality. If the user decided that this phrase or icon is not the one the user intended to use, the user can press the push button again to go to the next phrase or icon. This process can be repeated until the functionality marking display 20 displays a phrase or icon 27 that represents the functionality the user intended to use, then the user presses the push button continuously again for about three second to end the programming mode.

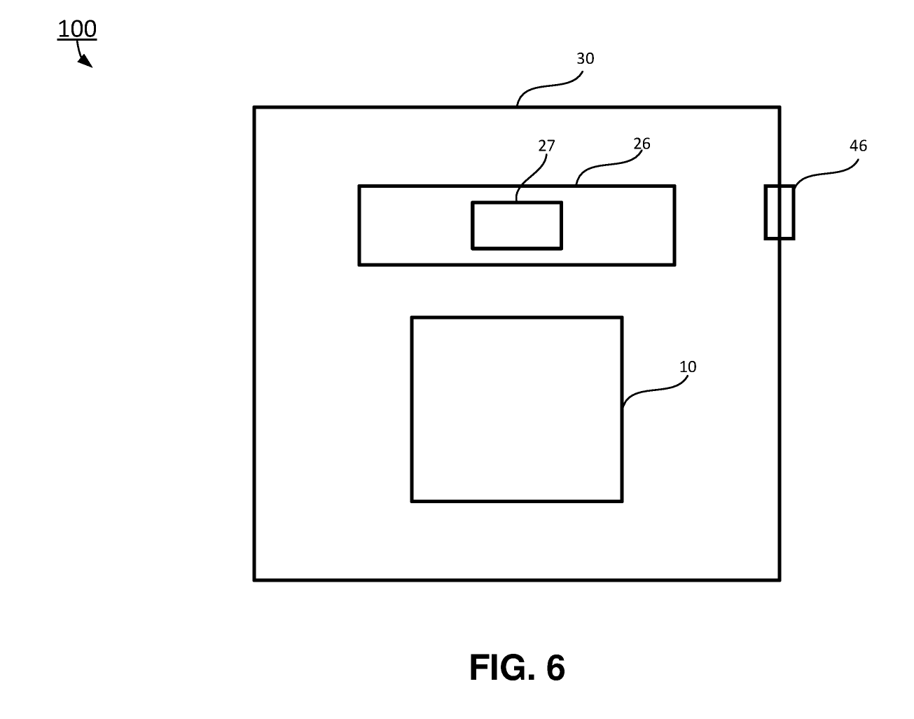

Referring now to FIG. 6, a front view of an exemplary switching device having an LCD screen 26 showing functionality markings and a functionality marking input interface is shown according to one embodiment of the present invention. In this embodiment, the switching device 100 has the switch 10, the functionality marking display 20, the face plate 30, and the functionality marking programmer 40. The functionality marking display 20 is the LCD screen 26 that displays various different phrases or icons 27 controlled by the control module 34, each of the various different phrases or icons 27 are used to represent various different functionalities of the switching device 100 as described in earlier section. The functionality marking programmer 40 is a functionality marking input interface 46. When the user connects a functionality marking programming device (not shown in FIG. 6) to the functionality marking input interface 46, the switching device 100 enters into programming mode. The first phrase or icon will be displayed indicating a first functionality. If the user decided that this phrase or icon is not the one the user intended to use, the user uses the functionality marking programming device to go to the next phrase or icon. This process can be repeated until the functionality marking display 20 displays a phrase or icon 27 that represents the functionality the user intended to use, then the user disconnects the functionality marking programming device from the functionality marking input interface 46 to end the programming mode.

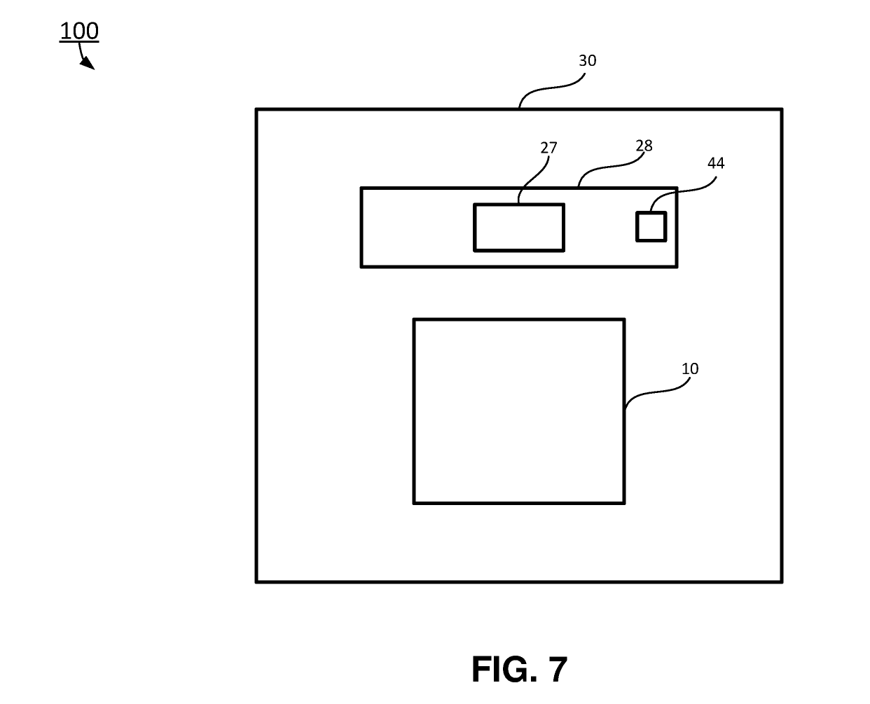

Referring now to FIG. 7, a front view of an exemplary switching device having a touchscreen 28 showing functionality marking 27 is shown according to one embodiment of the present invention. In this embodiment, the switching device 100 has the switch 10, the functionality marking display 20, the face plate 30, and the functionality marking programmer 40. The functionality marking display 20 is the touchscreen 28 that displays various different phrases or icons 27 controlled by the control module 34, each of the various different phrases or icons 27 are used to represent various different functionalities of the switching device 100 as described in earlier section. The functionality marking programmer 40 is a functionality marking selection icon 44 displayed on the touchscreen 28. When the user presses the functionality marking selection icon 44 continuously for about three seconds, the switching device 100 enters into programming mode. The first phrase or icon will be displayed indicating a first functionality. If the user decided that this phrase or icon is not the one the user intended to use, the user can press the push button again to go to the next phrase or icon. This process can be repeated until the functionality marking display 20 displays a phrase or icon 27 that represents the functionality the user intended to use, then the user presses the functionality marking selection icon 44 continuously again for about three second to end the programming mode.

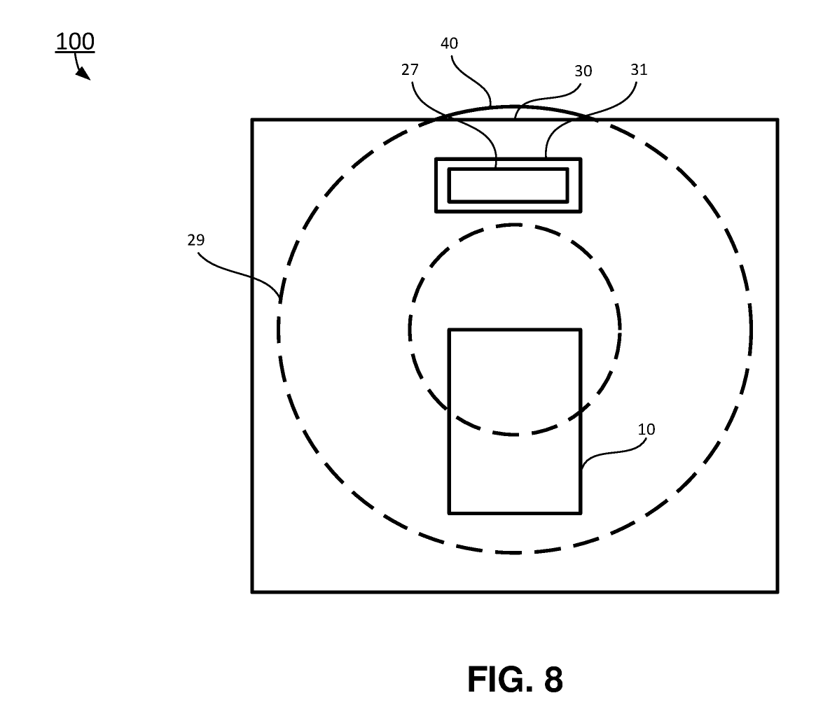

Referring now to FIG. 8, a front view of an exemplary switching device having a dial 29 showing functionality marking 27 through a functionality marking display window 31 is shown according to one embodiment of the present invention. In this embodiment, the switching device 100 has the switch 10, the functionality marking display 20, the face plate 30, and the functionality marking programmer 40. The functionality marking display 20 is the functionality marking display window 31 that displays various different phrases or icons 27, each of the various different phrases or icons 27 are used to represent various different functionalities of the switching device 100 as described in earlier section. The functionality marking programmer 40 is the dial 29 positioned behind the face plate 30. In one embodiment, the face plate 30 has an opening on the top so a portion of the dial 29 is exposed from the top of the face plate 30 such that the user can turn the dial to select one of various functionality markings as designated functionality marking 27, and display the selected functionality marking 27 through the functionality marking display window 31.

In another aspect, the present invention relates to a method of using a switching device 100 having programmable functionality markings. In certain embodiments, the method includes:
receiving functionality marking programming instructions from a user via a functionality marking programmer 40 of the switching device 100;
designating the functionality of at least one switch 10 with a functionality marking 27 according to the functionality marking programming instructions received; and
displaying the programmed functionality marking 27 of the switch 10 via a functionality marking display 20.

In certain embodiments, the switching device 100 includes: the at least one switch 10, the functionality marking programmer 40, the functionality marking display 20, and a face plate 30. The switch 10 is used to control power supply to an electrical appliance. The functionality marking programmer 40 allows a user to designate the switch 10 to a specific functionality with a corresponding functionality marking 27. The functionality marking display 20 displays the functionality marking 27 of the switch 10 programmed by the functionality marking programmer 40. The face plate 30 has an outside surface, and an inside surface. A circuit board 32 is installed on the inside surface of the face plate 30. The functionality marking display 20 is installed on the outside surface of the face plate 30. The circuit board 32 includes a control module 34. The control module 34 includes a processor 36, and a memory 38. The control module 34 is electrically coupled to the functionality marking programmer 40 and the functionality marking display 20.

In certain embodiments, the operation of receiving functionality marking programming instructions includes:
pressing a functionality marking selection push button 42 by the user to select one of the functionality markings;
pressing a functionality marking selection icon 44 on the touchscreen 28 by the user to select one of the functionality markings;
turning a dial 29 by the user to select one of the functionality marking signs; and
receiving the functionality marking programming instructions from a functionality marking programming device via a functionality marking input interface 46.

In certain embodiments, the operation of designating the functionality of at least one switch 10 with a functionality marking 27 includes:
pressing the functionality marking selection push button 42 by the user to select one of the functionality markings repeatedly until the desired functionality marking is displayed on the functionality marking display 20;
pressing the functionality marking selection icon 44 on the touchscreen 28 by the user to select one of the functionality markings repeatedly until the desired functionality is displayed on the touchscreen 28;
turning the dial 29 by the user to select one of the functionality markings repeatedly until the desired functionality marking sign is displayed in a functionality marking display window 31 of the face plate 30; and
using the functionality marking programming device by the user to program the functionality marking via the functionality marking input interface 46.

In certain embodiments, the operation of displaying the programmed functionality marking includes one or more of the following:
displaying a predetermined color through an LED array 22;
displaying a predetermined color through a multi-color LED 24;
displaying a predetermined functionality marking sign on the dial 29;
displaying a predetermined phrase on a display screen; and
displaying a predetermined icon on the display screen.

The predetermined color used for the LED array 22 and the multi-color LED 24 represents the designated functionality of the switch 10. The predetermined functionality marking sign is displayed on the dial 29 through the functionality marking display window 31 on the face plate 30. The predetermined functionality marking sign represents the designated functionality of the switch 10. Each of the predetermined phrase and the predetermined icon shown on the display screen represents the designated functionality of the switch 10. The display screen includes: an LED screen 25, an LCD screen 26, and a touchscreen 28.

In certain embodiments, the functionality marking 27 includes: a selection of various functionality markings displayed on the display screen, a selection of various functionality markings displayed on the dial 29, a selection of color displays of the LED array 22 color-coded for the functionalities, and a selection of color displays of the multiple-color LED 24 color-coded for the functionalities. The various functionality markings include: different phrases describing the predetermined functionalities, different icons showing the predetermined functionalities, and different functionality marking signs on the dial 29 showing the predetermined functionalities.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A switching device having programmable functionality markings comprising:
at least one switch configured to control power supply to an electrical appliance;
a functionality marking programmer configured to allow a user to designate the switch to a specific functionality with a corresponding functionality marking;
a functionality marking display configured to display the functionality marking of the switch programmed by the functionality marking programmer; and
a control module having a processor and a memory storing computer executable instructions configured to, when executed at the processor:
receive functionality marking programming instructions from the user via the functionality marking programmer;
designate the functionality of the at least one switch with a functionality marking according to the functionality marking programming instructions received; and
display the programmed functionality marking of the switch via the functionality marking display.

2. The switching device according to claim 1 further comprising a face plate having an outside surface, and an inside surface, wherein a circuit board is installed on the inside surface of the face plate, and the functionality marking display is installed on the outside surface of the face plate.

3. The switching device according to claim 2, wherein the circuit board comprises the control module, and the control module comprises the processor, and the memory.

4. The switching device according to claim 3, wherein the control module is electrically coupled to the functionality marking programmer for receiving the functionality marking programming instructions, and the functionality marking display for displaying the programmed functionality marking.

5. The switching device according to claim 1, wherein the functionality marking display comprises:
a light emitting diode (LED) array having a plurality of colored LEDs;
a multi-color LED;
a functionality marking display window on the face plate showing a plurality of functionality markings on a dial;
an LED screen;
a liquid crystal display (LCD) screen; and
a touchscreen having functionality marking programmer and functionality marking display.

6. The switching device according to claim 5, wherein the functionality marking comprises:
a selection of a plurality of functionality markings of the switch displayed on a display screen;
a selection of the plurality of functionality markings of the switch displayed on the dial;
a selection of color displays of the LED array color-coded for the functionalities of the switch; and
a selection of color displays of the multiple-color LED color-coded for the functionalities of the switch.

7. The switching device according to claim 6, wherein the plurality of functionality markings comprises:
a plurality of phrases describing the functionalities;
a plurality of icons showing the functionalities; and
a plurality of functionality marking signs on the dial showing the functionalities.

8. The switching device according to claim 7, wherein the display screen comprises the LED screen, the LCD screen, and the touchscreen.

9. The switching device according to claim 1, wherein the functionality marking programmer comprises:
a functionality marking selection push button;
a functionality marking selection icon on the touchscreen;
the dial; and
a functionality marking input interface.

10. The switching device according to claim 1, wherein the at least one switch comprises:
a toggle switch;
a rotary switch;
a push button switch;
a touch switch;
a push switch;
a pull switch;
a rocker switch;
a slide switch;
a light sensing switch;
a motion sensing switch; and
an LCD touchscreen switch.

11. A method of using a switching device having programmable functionality markings, comprising:
receiving functionality marking programming instructions from a user via a functionality marking programmer of the switching device;
designating the functionality of at least one switch with a functionality marking according to the functionality marking programming instructions received; and
displaying the programmed functionality marking of the switch via a functionality marking display.

12. The method according to claim 11, wherein the switching device comprises:
the at least one switch configured to control power supply to an electrical appliance;
the functionality marking programmer configured to allow a user to designate the switch to a specific functionality with a corresponding functionality marking; and
the functionality marking display configured to display the functionality marking of the switch programmed by the functionality marking programmer,
a face plate having an outside surface, and an inside surface, wherein a circuit board is installed on the inside surface of the face plate, and the functionality marking display is installed on the outside surface of the face plate.

13. The method according to claim 12, wherein the circuit board comprises a control module, wherein the control module comprises a processor, and a memory, and the control module is electrically coupled to the functionality marking programmer and the functionality marking display.

14. The method according to claim 10, wherein the operation of receiving functionality marking programming instructions comprises:
pressing a functionality marking selection push button by the user to select one of the plurality of functionality markings;
pressing a functionality marking selection icon on the touchscreen by the user to select one of the plurality of functionality markings;
turning a dial by the user to select one of the plurality of functionality marking signs; and
receiving the functionality marking programming instructions from a functionality marking programming device via a functionality marking input interface.

15. The method according to claim 14, wherein the operation of designating the functionality comprises:
pressing the functionality marking selection push button by the user to select one of the plurality of functionality markings repeatedly until the desired functionality marking is displayed on the functionality marking display;
pressing the functionality marking selection icon on the touchscreen by the user to select one of the plurality of functionality markings repeatedly until the desired functionality is displayed on the touchscreen;
turning the dial by the user to select one of the plurality of functionality markings repeatedly until the desired functionality marking sign is displayed in a functionality marking display window of the face plate; and
using the functionality marking programming device to program the functionality marking via the functionality marking input interface.

16. The method according to claim 15, wherein the operation of displaying the programmed functionality marking comprises one or more of following:
displaying a predetermined color through an LED array, wherein the predetermined color represents the designated functionality of the switch;
displaying a predetermined color through a multi-color LED, wherein the predetermined color represents the designated functionality of the switch;
displaying a predetermined functionality marking sign on the dial through the functionality marking display window on the face plate, wherein the predetermined functionality marking sign represents the designated functionality of the switch;
displaying a predetermined phrase on a display screen, wherein the predetermined phrase represents the designated functionality of the switch; and
displaying a predetermined icon on the display screen, wherein the predetermined icon represents the designated functionality of the switch,
wherein the display screen comprises an LED screen, an LCD screen, and a touchscreen.

17. The method according to claim 16, wherein the functionality marking comprises:
a selection of the plurality of functionality markings of the switch displayed on the display screen;
a selection of the plurality of functionality marking signs of the switch displayed on the dial;
a selection of color displays of the LED array color-coded for the functionality of the switch; and
a selection of color displays of the multiple-color LED color-coded for the functionality of the switch.

18. The method according to claim 17, wherein the plurality of functionality markings comprises:
a plurality of phrases shown on the display screen describing the functionality of the switch;
a plurality of icons shown on the display screen representing the functionality of the switch; and
a plurality of functionality marking signs on the dial showing the functionality of the switch.

19. The method according to claim 18, wherein the display screen comprises the LED screen, the LCD screen, and the touchscreen.

20. The method according to claim 10, wherein the at least one switch comprises:
a toggle switch;
a rotary switch;
a push button switch;
a touch switch;
a push switch;
a pull switch;
a rocker switch;
a slide switch; and
a light sensing switch;
a motion sensing switch; and
an LCD touchscreen switch.
